(19) United States
(12) Patent Application Publication
(10) Pub. No.: US 2026/0171316 A1
(43) Pub. Date: Jun. 18, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Taemin Kim, Suwon-si (KR); Kyungmin Ok, Suwon-si (KR); Geumhee Yun, Suwon-si (KR)

(73) Assignee: SAMSUNG ELECTRO-MECHANICS CO., LTD., Suwon-si (KR)

(21) Appl. No.: 19/206,888

(22) Filed: May 13, 2025

(30) Foreign Application Priority Data
Dec. 13, 2024 (KR) 10-2024-0186272

(51) Int. Cl. H01G 4/224; H01G 4/005; H01G 4/12; H01G 4/232; H01G 4/248; H01G 4/30; H01G 13/00

(52) U.S. Cl. CPC H01G 4/224; H01G 4/005; H01G 4/1227; H01G 4/232; H01G 4/248; H01G 4/30; H01G 13/003

(57) ABSTRACT

A multilayer ceramic capacitor includes a capacitor body having a first surface and a second surface facing in a first direction, a third surface and a fourth surface facing in a second direction and connecting the first surface and the second surface, and a fifth surface and a sixth surface facing in a third direction and connecting the first surface and the second surface, and including a plurality of dielectric layers and a plurality of internal electrodes laminated in the third direction, an external electrode located on the outside of the capacitor body, and a margin coating layer located on the third surface and the fourth surface and including a barium titanate-based compound and Nb, wherein the Nb content included in the margin coating layer is 0.5 part by mole to 1 part by mole based on 100 parts by mole of Ti included in the margin coating layer.

### CROSS-REFERENCE TO RELATED APPLICATION

This application claims priority to and the benefit of Korean Patent Application No. 10-2024-0186272 filed at the Korean Intellectual Property Office on Dec. 13, 2024, the entire contents of which are incorporated herein by reference.

### BACKGROUND

The disclosure of the present application relates to a multilayer ceramic capacitor and a method of manufacturing the same.

Electronic components that use ceramic materials include capacitors, inductors, piezoelectric elements, varistors, and thermistors. Among these ceramic electronic components, a multilayer ceramic capacitor MLCC may be used in various electronic devices due to its advantages of being compact, high capacity, and easy to mount.

For example, multilayer ceramic capacitors may be used as chip-shaped capacitors mounted on the substrates of various electronic products, such as video devices such as liquid crystal displays (LCDs), plasma display panels (PDPs), and organic light emitting diodes (OLEDs), computers, personal portable terminals, and smartphones, to charge or discharge electricity.

With the recent miniaturization of electronic products, multilayer ceramic capacitors are also required to be ultra-small and ultra-high capacity. To this end, multilayer ceramic capacitors are being manufactured with a structure in which the dielectric layers and internal electrode layers are thinned and a greater number of dielectric layers and internal electrode layers are laminated. These ultra-small and ultra-high-capacity multilayer ceramic capacitors have recently been used in fields requiring a high level of reliability, such as electric vehicles, and therefore high stability and reliability are required accordingly.

### SUMMARY

According to an aspect of the present disclosure, a multilayer ceramic capacitor having improved reliability and structural stability may be provided.

According to another aspect of the present disclosure, a method of manufacturing a multilayer ceramic capacitor having improved reliability and structural stability may be provided.

However, embodiments of the present disclosure are not limited to those mentioned above, and may be variously extended in the scope of the technical ideas included in the present disclosure.

According to some embodiments of the present disclosure, a multilayer ceramic capacitor is provided, including a capacitor body having a first surface and a second surface facing in a first direction, a third surface and a fourth surface facing in a second direction and connecting the first surface and the second surface, and a fifth surface and a sixth surface facing in a third direction and connecting the first surface and the second surface, and including a plurality of dielectric layers and a plurality of internal electrodes laminated in the third direction, an external electrode located on the outside of the capacitor body, and a margin coating layer located on the third surface and the fourth surface and including a barium titanate-based compound and Nb. The Nb content included in the margin coating layer is 0.5 parts by mole to 1 part by mole based on 100 parts by mole of Ti included in the margin coating layer.

The maximum length of the margin coating layer in the second direction may be greater than 0 μm and less than or equal to 20 μm.

Nb included in the margin coating layer may be derived from a polyvinyl butyral (PVB)-Nb composite.

The external electrode may be located on the first surface and the second surface.

The margin coating layer may be in contact with the dielectric layer or the internal electrode.

At least one surface of the margin coating layer may be exposed to the outside of the multilayer ceramic capacitor.

According to another embodiment of the present disclosure, a method of manufacturing a multilayer ceramic capacitor includes forming a dielectric green sheet laminate by laminating dielectric green sheets on which a conductive paste layer is formed in a third direction, cutting the dielectric green sheet laminate in the third direction to form a pre-capacitor body with one end of the conductive paste layer exposed, firing the pre-capacitor body to form a capacitor body including a plurality of dielectric layers and a plurality of internal electrodes laminated in the third direction, applying a margin slurry including a polyvinyl butyral (PVB)-Nb composite on a margin sheet, positioning the margin sheet and the margin slurry on the capacitor body so that the margin slurry covers the exposed end of the internal electrode, and forming a margin coating layer by firing the margin slurry and the margin sheet. The Nb content included in the margin coating layer is about 0.5 parts by mole to 1 part by mole based on 100 parts by mole of Ti included in the margin coating layer.

A PVB-Nb composite may include a compound in which PVB and Nb are bonded through a chemical bond such as an ionic bond.

The PVB-Nb composite may include a polymer including PVB-derived repeating units, polyvinyl alcohol (PVA)-derived repeating units, and (PVAc)-derived repeating units.

The PVB-Nb composite is formed by adding a PVB source and an Nb source to a solvent, mixing, and drying.

The PVB source may include a polymer including PVB-derived repeating units, PVA-derived repeating units, and PVAc-derived repeating units.

The polymer of the PVB source may further include a repeating unit having a carboxyl group at a terminal.

Nb ions included in the Nb source may be bonded to the carboxyl group to form the PVB-Nb composite.

The Nb source may include niobium ethoxide.

The margin slurry may further include a barium titanate-based compound.

The capacitor body may have a first surface and a second surface facing in a first direction, a third surface and a fourth surface facing in a second direction and connecting the first surface and the second surface, and a fifth surface and a sixth surface facing in a third direction and connecting the first surface and the second surface, the margin coating layer may be located on the third surface and the fourth surface, and the maximum length of the margin coating layer in the second direction may be greater than 0 μm and less than or equal to 20 μm.

According to some embodiments of the present disclosure, the density and moisture resistance reliability of the margin coating layer may be improved, and the connectivity between the margin coating layer and the capacitor body may be improved.

According to some embodiments of the present disclosure, by disposing the margin coating layer separately from the capacitor body, deformation of internal electrodes may be suppressed, and the reliability and stability of the multilayer ceramic capacitor may be improved.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor cut along line II-II′ of FIG. 1.

FIG. 4 is a flow chart illustrating a method of manufacturing a multilayer ceramic capacitor according to an embodiment.

FIGS. 5 to 8 are cross-sectional views illustrating a method of manufacturing a multilayer ceramic capacitor according to an embodiment.

FIG. 9 is a scanning electron microscopy-microstructure image database and analysis system (SEM-MiDAS) analysis image of a multilayer ceramic capacitor according to Example 1.

FIG. 10 is an optical microscope image of a multilayer ceramic capacitor according to Comparative Example 1.

FIG. 11 is an SEM-MiDAS analysis image of the multilayer ceramic capacitor according to Example 1.

FIG. 12 is an SEM-MiDAS analysis image of the multilayer ceramic capacitor according to Comparative Example 1.

FIG. 13 is a graph showing the results of a moisture resistance reliability evaluation of the multilayer ceramic capacitor according to Example 1.

FIG. 14 is a graph showing the results of a moisture resistance reliability evaluation of the multilayer ceramic capacitor according to Comparative Example 1.

### DETAILED DESCRIPTION OF THE EMBODIMENTS

Hereinafter, the present disclosure will be described in detail with reference to the accompanying drawings, in which embodiments of the present disclosure are shown. The drawings and description are to be regarded as illustrative in nature and not restrictive, and like reference numerals designate like elements throughout the specification. In the accompanying drawings, some components are exaggerated, omitted, or schematically illustrated, and the size of each component does not entirely reflect the actual size.

The accompanying drawings are intended only to facilitate understanding of the exemplary embodiments disclosed in this specification, and it is to be understood that the technical ideas disclosed herein are not limited by the accompanying drawings and include all modifications, equivalents, or substitutions that are within the range of the ideas and technology of the present disclosure.

Although terms “first,” “second,” and the like are used to explain various components, the components are not limited to such terms. These terms are only used to distinguish one component from another component.

It should be understood that when an element such as a layer, film, region, or substrate is referred to as being “on” or “above” another element, it may be directly on the other element or intervening elements may also be present. In contrast, when an element is referred to as being “directly on” another element, there are no intervening elements present. Further, when an element is referred to as being “on” or “above” a reference element, it may be located above or below the reference element, and it may not necessarily be referred to as being located “on” or “above” it in a direction opposite to gravity.

Throughout the specification, the terms “comprise” and “have” are intended to specify the presence of stated features, numbers, steps, operations, components, or a combination thereof, but do not preclude the presence or addition of one or more other features, numbers, steps, operations, components, and/or groups thereof. Therefore, unless explicitly stated to the contrary, the word “comprise” and variations such as “comprises” and “comprising” should be understood to imply the inclusion of stated elements but not the exclusion of any other elements.

In addition, the phrase “on a plane” means a view from a position above the object (e.g., from the top), and the phrase “in a cross-section” means a view of a cross-section of the object which is vertically cut from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

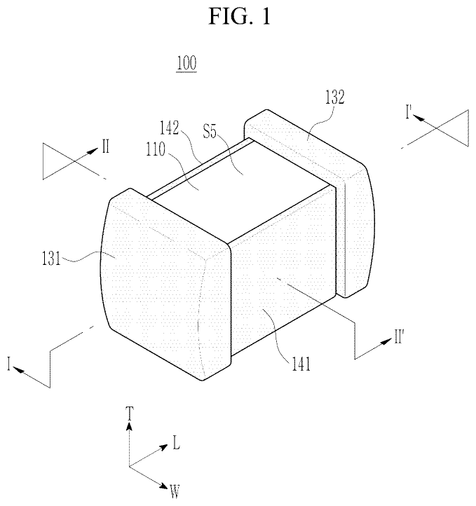

Hereinafter, a multilayer ceramic capacitor according to an embodiment of the present disclosure will be described with reference to FIGS. 1 to 3.

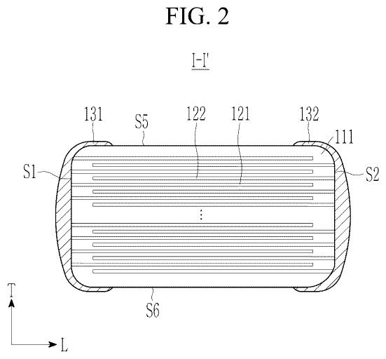

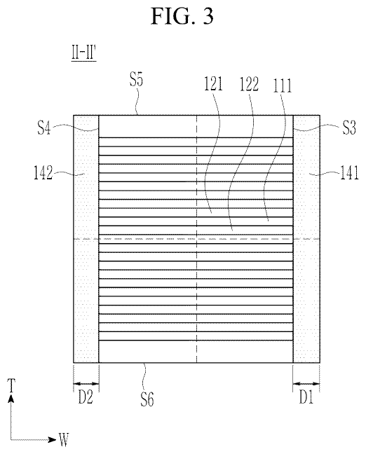

FIG. 1 is a perspective view schematically showing a multilayer ceramic capacitor according to an embodiment. FIG. 2 is a schematic cross-sectional view of the multilayer ceramic capacitor taken along line I-I′ of FIG. 1. FIG. 3 is a schematic cross-sectional view of the multilayer ceramic capacitor cut along line II-II′ of FIG. 1.

Referring to FIGS. 1 to 3, a multilayer ceramic capacitor 100 may include a capacitor body 110 including a dielectric layer 111 and internal electrodes 121 and 122, and external electrodes 131 and 132 disposed on the outside of the capacitor body 110. The external electrodes 131 and 132 may include a first external electrode 131 and a second external electrode 132 disposed at both ends facing in a length direction (L-axis direction) of the capacitor body 110.

The L-axis, W-axis, and T-axis shown in FIGS. 1 to 3 and 5 to 8 represent the length direction, width direction, and lamination direction of the capacitor body 110, respectively. Here, for example, the lamination direction (T-axis direction) may be a direction perpendicular to the wide surface (main surface) of the sheet-shaped components, and may be used as the same concept as the lamination direction in which the dielectric layer 111 is laminated. The length direction (L-axis direction) may be a direction that intersects (is approximately perpendicular to) the lamination direction (T-axis direction) and extends parallel to the wide surface (main surface) of the sheet-shaped components, and may be, for example, a direction in which the first external electrode 131 and the second external electrode 132 are located on both sides. The width direction (W-axis direction) may be a direction that intersects (is approximately perpendicular to) the lamination direction (T-axis direction) and the length direction (L-axis direction) and extends parallel to the wide surface (main surface) of the sheet-shaped components, and the length in the length direction (L-axis direction) of the sheet-shaped components may be greater than the length in the width direction (W-axis direction).

For example, the capacitor body 110 may have a roughly hexahedral shape.

The length direction (L-axis direction) is sufficient as long as a first surface S1 and a second surface S2 face each other, and the length in the length direction (L-axis direction) does not necessarily need to be greater than the length in the width direction (W-axis direction).

Hereinafter, for convenience of description, both surfaces facing in a first direction of the capacitor body 110 are defined as the first surface S1 and the second surface S2, both surfaces connected to the first surface S1 and the second surface S2 and facing in a second direction are defined as a third surface S3 and a fourth surface S4, and both surfaces connected to the first surface S1 and the second surface S2, connected to the third surface S3 and the fourth surface S4, and facing in a third direction are defined as a fifth surface S5 and a sixth surface S6.

In this specification, the first direction and the length direction (L-axis direction) may be used with the same meaning, the second direction and the width direction (W-axis direction) may be used with the same meaning, and the third direction and the lamination direction (T-axis direction) may be used with the same meaning.

The first and second directions may intersect or, for example, be perpendicular to each other. The second and third directions may intersect or, for example, be perpendicular to each other. The third direction may intersect each of the first and second directions, or, for example, be perpendicular to each other.

The sixth surface S6, which is a lower surface of the capacitor body 110, may be a surface facing the mounting direction of the multilayer ceramic capacitor 100. At least one of the first surface S1 to the sixth surface S6 may be flat. Alternatively, at least one of the first surface S1 to the sixth surface S6 may be curved surfaces with a convex central portion, and the edges, which are the boundaries of each surface, may be rounded.

The shape and size of the capacitor body 110 and the number of laminations of the dielectric layers 111 are not limited to those shown in the drawings of the present disclosure.

The capacitor body 110 may include the dielectric layer 111 and internal electrode layers 121 and 122. The capacitor body 110 may include a plurality of dielectric layers 111.

The capacitor body 110 may include the plurality of dielectric layers 111, and the first internal electrodes 121 and the second internal electrodes 122 alternately arranged in the lamination direction (T-axis direction) with the dielectric layers 111 interposed therebetween.

The boundaries between adjacent dielectric layers 111 may be so integrated that they are difficult to identify without using a scanning electron microscope (SEM).

The capacitor body 110 may include an active region. The active region may be a portion that contributes to forming the capacity of the multilayer ceramic capacitor 100. For example, the active region may be a region where the first internal electrode 121 or the second internal electrode 122 laminated in the lamination direction (T-axis direction) overlap.

The capacitor body 110 may further include a cover region.

The cover region may be located adjacent to the first surface and the second surface of the active region in the lamination direction (T-axis direction) as a lamination direction margin portion. For example, a single dielectric layer 111 or two or more dielectric layers 111 may be laminated on the upper and lower surfaces of the active region, respectively, to provide the cover region.

The capacitor body 110 may not include a separate width direction (W-axis direction) margin portion. For example, one end of the internal electrodes 121 and 122 in the width direction (W-axis direction) may be exposed to the third surface S3 and the fourth surface S4 of the capacitor body 110. The exposed upper end may be covered by margin coating layers 141 and 142 described below.

For example, the cover region and the margin coating layers 141 and 142 may prevent damage to the first internal electrode 121 and the second internal electrode 122 due to physical or chemical stress.

The dielectric layer 111 may include a barium titanate-based compound as a primary component. For example, by using the barium titanate-based compound as a dielectric based material, the dielectric properties of the multilayer ceramic capacitor 100 may be secured.

The barium titanate-based compound may include at least one selected from the group consisting of BaTiO₃, BaZrO₃, BaSnO₃, CaTiO₃, CaZrO₃, CaSnO₃, SrTiO₃, SrZrO₃, SrSnO₃, and the like. These may be used alone or in combination of two or more.

The dielectric layer 111 may further include a secondary component.

The secondary component may include at least one selected from the group consisting of manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), and the like. These may be used alone or in combination of two or more.

According to some embodiments, the average thickness (average length in the T-axis direction) of the dielectric layer 111 may be about 1.0 μm to 8.0 μm. According to another embodiment, the average thickness (average length in the T-axis direction) of the dielectric layer 111 may be about 2 μm to 6 μm. In the above ranges, the reliability of the multilayer ceramic capacitor 100 may be further improved.

For example, the average thickness of the dielectric layer 111 may be obtained as the arithmetic average of the thicknesses of the dielectric layer 111 measured at 10 points spaced at predetermined intervals from a reference point, where the reference point is the center point in the length direction (L-axis direction) or width direction (W-axis direction) of the dielectric layer 111 in an SEM analysis image of a cross-section (L-T cross-section) cut perpendicular to the width direction in the length direction (L-axis direction) and the lamination direction (T-axis direction) at the center of the width direction (W-axis direction) of the multilayer ceramic capacitor 100. The intervals of the 10 points may be adjusted depending on the scale of the SEM analysis image, and may be, for example, about 1 μm to 100 μm, 1 μm to 50 μm, or 1 μm to 10 μm. At this time, all 10 points must be located within the dielectric layer 111, and if all 10 points are not located within the dielectric layer 111, the position of the reference point may be changed, or the interval between the 10 points may be adjusted.

The first internal electrode 121 and the second internal electrode 122 of the internal electrodes 121 and 122 may have different polarities. For example, the first internal electrode 121 and the second internal electrode 122 may be alternately disposed to face each other in the lamination direction (T-axis direction) with the dielectric layer 111 therebetween. For example, one end in the length direction (L-axis direction) of the first internal electrode 121 may be exposed through the first surface S1 of the capacitor body 110, and one end in the length direction (L-axis direction) of the second internal electrode 122 may be exposed through the second surface S2 of the capacitor body 110.

The first internal electrode 121 and the second internal electrode 122 may be electrically insulated from each other by the dielectric layer 111 disposed therebetween.

An end of the first internal electrode 121 exposed through the first surface S1 of the capacitor body 110 may be electrically connected to the first external electrode 131. For example, an end of the second internal electrode 122 exposed through the second surface S2 of the capacitor body 110 may be electrically connected to the second external electrode 132.

The first internal electrode 121 and the second internal electrode 122 may each include a conductive metal. For example, the conductive metal may include a metal such as Ni, Cu, Ag, Pd, Au, or an alloy thereof (e.g., an Ag—Pd alloy).

The first internal electrode 121 and the second internal electrode 122 may include dielectric particles of the same composition as the ceramic material included in the dielectric layer 111.

The first internal electrode 121 and the second internal electrode 122 may be formed using a conductive paste including a conductive metal. The printing method of the conductive paste may be a screen-printing method or a gravure printing method.

According to some embodiments, the average thickness of the first internal electrode 121 and the second internal electrode 122 may be about 0.1 μm to 2 μm. In the above range, as the multilayer ceramic capacitor 100 is implemented and thinned, resistance may be further reduced.

The average thickness of the first internal electrode 121 and the second internal electrode 122 may be measured by the SEM analysis. The SEM analysis may be substantially identical to the above-described method of measuring the average thickness of the dielectric layer 111.

The capacitor body 110 may be formed by firing a laminate in which a plurality of dielectric layers 111 and the internal electrode layers 121 and 122 are laminated.

Referring to FIG. 2, the first external electrode 131 and the second external electrode 132 may have different polarities.

The first external electrode 131 may be electrically connected to the exposed portion of the first internal electrode 121. For example, the second external electrode 132 may be electrically connected to a portion where the second internal electrode 122 is exposed.

When a predetermined voltage is applied to the first external electrode 131 and the second external electrode 132, charges may be accumulated between the opposing first internal electrode 121 and the second internal electrode 122. The capacitance of the multilayer ceramic capacitor 100 may be proportional to the overlapped area on a plane of the first internal electrode 121 and the second internal electrode 122 that overlap each other in the lamination direction (T-axis direction) in the active region.

The first external electrode 131 and the second external electrode 132 may each include first and second connecting portions (not shown) disposed on the first surface S1 and the second surface S2 of the capacitor body 110 and connected to the first internal electrode 121 and the second internal electrode 122. The first external electrode 131 and the second external electrode 132 may each include first and second band portions (not shown) disposed at corners where the first surface S1 and the second surface S2, the third surface S3 and the fourth surface S4, or the fifth surface S5 and the sixth surface S6 of the capacitor body 110 meet.

The first and second band portions may extend from the first and second connecting portions to a portion of the third surface S3 and the fourth surface S4 or the fifth surface S5 and the sixth surface S6 of the capacitor body 110, respectively. The first and second band portions may improve the adhesion strength of the first external electrode 131 and the second external electrode 132.

The first external electrode 131 and the second external electrode 132 may each include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include at least one selected from the group consisting of copper (Cu), nickel (Ni), silver (Ag), palladium (Pd), gold (Au), platinum (Pt), tin (Sn), tungsten (W), titanium (Ti), lead (Pb), an alloy thereof, and a combination thereof. For example, in some embodiments, copper (Cu) may include a copper (Cu) alloy. When the conductive metal contains copper, a metal other than copper may be contained in an amount of no more than 5 parts by mole based on 100 parts by mole of copper.

The glass may include a composition containing a mixture of oxides—for example, at least one selected from the group consisting of silicon oxide, boron oxide, aluminum oxide, transition metal oxide, alkali metal oxide, and alkaline-earth metal oxide.

The transition metal may include at least one selected from the group consisting of zinc (Zn), titanium (Ti), copper (Cu), vanadium (V), manganese (Mn), iron (Fe), and nickel (Ni). The alkali metal may include at least one selected from the group consisting of lithium (Li), sodium (Na), and potassium (K). The alkaline-earth metal may include at least one selected from the group consisting of magnesium (Mg), calcium (Ca), strontium (Sr), and barium (Ba).

In some embodiments, the conductive resin layer may be formed on the sintered metal layer, such as covering the sintered metal layer entirely. In an embodiment, the first external electrode 131 and the second external electrode 132 may not include the sintered metal layer. In this case, the conductive resin layer may be in direct contact with the capacitor body 110.

The conductive resin layer extends to the third surface S3 and the fourth surface S4 or the fifth surface S5 and the sixth surface S6 of the capacitor body 110, and the length of the region (i.e., the band portion) where the conductive resin layer extends and is disposed to the third surface S3 and the fourth surface S4 or the fifth surface S5 and the sixth surface S6 of the capacitor body 110 may be greater than the length of the region (i.e., the band portion) where the sintered metal layer extends and is disposed to the third surface S3 and the fourth surface S4 or the fifth surface S5 and the sixth surface S6 of the capacitor body 110. In an embodiment, the conductive resin layer is formed on the sintered metal layer and may entirely cover the sintered metal layer.

The above conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include phenolic resin, acrylic resin, silicone resin, epoxy resin, or polyimide resin.

The conductive metal included in the conductive resin layer may have a spherical shape, a flake shape, or a combination thereof. For example, the conductive metal may be formed solely in the form of flakes, solely in the form of spherical shapes, or in the form of a mixture of flakes and spherical shapes.

Here, the spherical shape may also include a shape that is not a perfect spherical shape—for example, a shape in which the length ratio of the major axis and the minor axis (major axis/minor axis) is 1.45 or less. Flake shape powder refers to a powder with a flat and elongated shape, and is not particularly limited, but may, for example, have a length ratio of the major axis and the minor axis (major axis/minor axis) of 1.95 or more.

The first external electrode 131 and the second external electrode 132 may further include a plating layer disposed outside of the conductive resin layer.

The plating layer may include at least one selected from the group consisting of nickel (Ni), copper (Cu), tin (Sn), palladium (Pd), platinum (Pt), gold (Au), silver (Ag), tungsten (W), titanium (Ti), and lead (Pb), either alone or in an alloy thereof. For example, the plating layer may be a nickel (Ni) plating layer or a tin (Sn) plating layer, may be a form in which the nickel (Ni) plating layer and the tin (Sn) plating layer are sequentially laminated, or may be a form in which the tin (Sn) plating layer, the nickel (Ni) plating layer, and the tin (Sn) plating layer are sequentially laminated. Additionally, the plating layer may include a plurality of nickel (Ni) plating layers and/or a plurality of tin (Sn) plating layers.

The plating layer may improve mountability to the substrate, structural reliability, durability to the outside, heat resistance, and equivalent series resistance (ESR) of the multilayer ceramic capacitor 100.

According to some embodiments of the present disclosure, the multilayer ceramic capacitor 100 may include the margin coating layers 141 and 142 located on the third surface S3 and the fourth surface S4 facing each other in the width direction (W-axis direction) and including a barium titanate-based compound and niobium (Nb). The margin coating layers 141 and 142 may be provided as width direction (W-axis direction) margin portions of the multilayer ceramic capacitor 100 that are disposed adjacent to both width direction (W-axis direction) side surfaces (the third surface S3 and the fourth surface S4) of the active region. With the margin coating layers 141 and 142, the density and moisture resistance reliability of the width direction (W-axis direction) margin portion of the multilayer ceramic capacitor 100 may be improved, and the connectivity between the margin coating layers 141 and 142 and the capacitor body 110 may be improved. In addition, by disposing the margin coating layers 141 and 142 separately from the capacitor body 110, deformation of the internal electrodes 121 and 122 may be suppressed, and the reliability and stability of the multilayer ceramic capacitor 100 may be improved.

The margin coating layers 141 and 142 may include a first margin coating layer 141 located on the third surface S3 of the capacitor body 110 and a second margin coating layer 142 located on the fourth surface S4.

In some embodiments, the margin coating layers 141 and 142 may be in contact with the dielectric layer 111 and the internal electrodes 121 and 122. For example, the margin coating layers 141 and 142 may be electrically connected by contacting one end of the dielectric layer 111 exposed to the third surface S3 or the fourth surface S4 of the capacitor body 110 and one end of the internal electrodes 121 and 122. Accordingly, the side surface of the active region may be protected from external impact and/or contamination.

The margin coating layers 141 and 142 may be located on the capacitor body 110 in the form of a sheet or thin film.

The barium titanate-based compound included in the margin coating layers 141 and 142 may include BaTiO₃, CaTiO₃, SrTiO₃, or the like. These may be used alone or in combination of two or more.

In some embodiments, the Nb content included in the margin coating layers 141 and 142 may be about 0.5 parts by mole to about 1 part by mole based on 100 parts by mole of titanium (Ti) included in the margin coating layers 141 and 142. In some embodiments, the Nb content included in the margin coating layers 141 and 142 may be about 0.5, 0.6, 0.7, 0.8, 0.9 parts by mole or more and/or about 1, 0.9, 0.8, 0.7 or 0.6 part by mole or less based on 100 parts by mole of titanium (Ti) included in the margin coating layers 141 and 142. In the above range, the density of the margin coating layers 141 and 142 may be sufficiently improved, so that the moisture resistance, reliability, and structural stability of the multilayer ceramic capacitor 100 may be further improved.

In order to measure the presence of the margin coating layer and the content of components of the margin coating layer, the multilayer ceramic capacitor 100 may be fixed with an epoxy resin and polished with a polisher so that a cross-section (W-T cross-section) cut in the width direction (W-axis direction) and the lamination direction (T-axis direction) perpendicular to the length direction from the center of the length direction (L-axis direction) of the multilayer ceramic capacitor 100 is exposed. The polishing may be performed so that half of the length in the length direction (L-axis direction) is removed. In the exposed W-T cross-section, a square region having a length of 20 μm in the width direction (W-axis direction) and a length of 200 μm in the lamination direction (T-axis direction) may be set, with a line extending in the width direction (W-axis direction) through the center of the lamination direction (T-axis direction) of the margin coating layers 141 and 142 as the center line. The square region may be divided into 10 sub-square regions each having the width direction (W-axis direction) length of 20 μm and the lamination direction (T-axis direction) length of 20 μm. For each of the sub-square regions, a scanning electron microscopy-microstructure image database and analysis system (SEM-MiDAS) or a transmission electron microscopy-energy dispersive X-ray spectroscopy (TEM-EDS) may be performed to measure the content of elements (Nb, Ti, etc.) included in the margin coating layers 141 and 142, the grain size, or the number of pores. The Nb content may be evaluated by averaging the contents of all Nb elements included in the 10 sub-square regions.

The maximum lengths D1 and D2 in the width direction (W-axis direction) of the margin coating layers 141 and 142 may be greater than 0 μm and less than or equal to about 20 μm. The maximum length D1 of the first margin coating layer 141 in the width direction (W-axis direction) and the maximum length D2 of the second margin coating layer 142 in the width direction (W-axis direction) may be greater than 0 μm and less than or equal to about 20 μm, respectively, and may be about 5, 6, 7, 8, 9, 10, 11, 12, 13, 14, 15, 16, 17, 18 or 19 μm or more and/or about 20, 19, 18, 17, 16, 15, 14, 13, 12, 11, 10, 9, 8, 7 or 6 μm or less. Within the above range, the multilayer ceramic capacitor 100 may be sufficiently miniaturized while protecting the active region from external impact or contamination.

By performing the TEM-EDS analysis or the SEM analysis on the W-T cross-section of the multilayer ceramic capacitor 100, the lengths D1 and D2 in the width direction (W-axis direction) at the point where the length in the width direction (W-axis direction) of the margin coating layers 141 and 142 is maximum may be measured.

In some embodiments, Nb included in the margin coating layers 141 and 142 may be derived from a polyvinyl butyral (PVB)-Nb composite. Accordingly, the sinterability and density of the margin coating layers 141 and 142 may be further improved, and the connectivity/bonding strength with the capacitor body 110 may be further enhanced. The PVB-Nb composite may include a polymer such as PVB or a copolymer of PVB, a polyvinyl alcohol (PVA), and/or a polyvinyl acetate (PVAc). The PVB-Nb composite is described in detail later in the description of a method of manufacturing the multilayer ceramic capacitor 100.

Hereinafter, a method of manufacturing the multilayer ceramic capacitor 100 according to some embodiments of the present disclosure will be described.

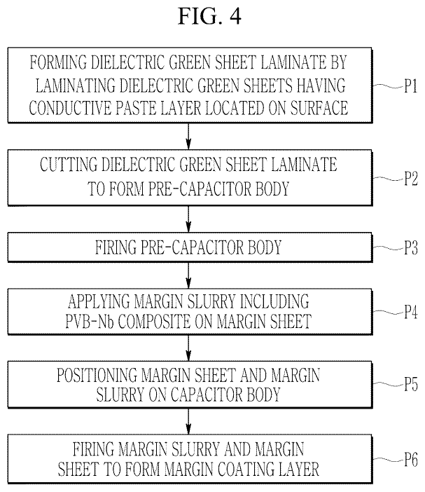

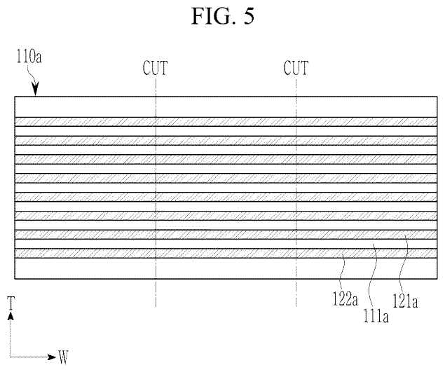

FIG. 4 is a flow chart illustrating a method of manufacturing a multilayer ceramic capacitor according to an embodiment. FIGS. 5 to 8 are cross-sectional views illustrating a method of manufacturing a multilayer ceramic capacitor according to an embodiment. FIGS. 5 to 8 may each represent the cross-section (W-T cross-section) of a dielectric green sheet laminate, a pre-capacitor, or a laminated ceramic capacitor observed from the same direction as FIG. 3.

Referring to FIGS. 4 and 5, a dielectric green sheet 111a having conductive paste layers 121a and 122a located on the surface of the dielectric green sheet may be laminated in the lamination direction (T-axis direction) to form a dielectric green sheet laminate 110a (e.g., step P1). The dielectric green sheet laminate 110a may refer to a laminated structure at a step before a pre-capacitor body 110b is manufactured by cutting it by dicing or the like.

In the manufacturing process of the dielectric green sheet laminate 110a, a dielectric paste that becomes the dielectric layer 111 after firing and a conductive paste that becomes the internal electrodes 121 and 122 after firing may be prepared.

A plasticized powder may be obtained by uniformly mixing and drying the dielectric powder by wet mixing or the like, and then heat-treating it under predetermined conditions. The dielectric paste may be manufactured by adding an organic vehicle or an aqueous vehicle to the plasticized powder, heating, and mixing.

The dielectric paste may be formed into a sheet using a technique such as a doctor blade method to obtain the dielectric green sheet. For example, the dielectric paste may include additives selected from various dispersants, plasticizers, dielectrics, secondary component compounds, and/or glasses.

The conductive paste for the internal electrodes may be prepared by mixing a conductive powder made of a conductive metal or an alloy thereof with a binder or solvent.

The conductive paste for the internal electrodes may contain indium (In).

The conductive paste for the internal electrodes may contain a ceramic powder (for example, barium titanate powder) as a co-material. The co-material may suppress sintering of the conductive powder during the firing process.

The conductive paste for the internal electrodes may be applied in a predetermined pattern on the surface of the dielectric green sheet 111a using various printing methods such as screen-printing or a transfer method. The dielectric green sheet 111a having an internal electrode pattern (the conductive paste layers 121a and 122a) formed thereon may be laminated in a plurality of layers and pressed in the lamination direction (T-axis direction) to obtain the dielectric green sheet laminate 110a. The dielectric green sheet 111a and the internal electrode pattern (the conductive paste layers 121a and 122a) may be laminated on the upper and lower surfaces of the dielectric green sheet laminate 110a in the lamination direction (T-axis direction) so that the dielectric green sheet 111a is located.

The dielectric green sheet laminate 110a may be solidified and dried to remove plasticizers, etc., if necessary, and after being solidified and dried, the dielectric green sheet laminate may be barrel polished using a horizontal centrifugal barrel machine, or the like. In the above barrel polishing, the dielectric green sheet laminate 110a is placed into a barrel container with media and polishing liquid, and rotational motion or vibration is applied to the barrel container, thus unnecessary parts, such as burrs generated during cutting, may be polished. For example, after barrel polishing, the dielectric green sheet laminate 110a may be washed with a cleaning solution such as water and dried.

The dielectric green sheet laminate 110a may be debindered.

The conditions of the debinder treatment may be appropriately adjusted depending on the primary component composition of the dielectric layer or the primary component composition of the internal electrode. For example, the rate of temperature rise during the debinder treatment may be 5° C./hour to 300° C./hour, the support temperature may be 180° C. to 400° C., and the temperature holding time may be 0.5 hours to 24 hours. The debinder atmosphere may be air or a reducing atmosphere.

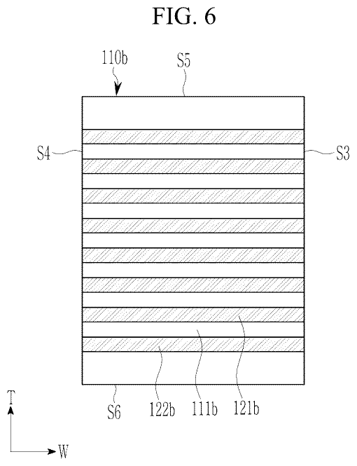

Referring to FIGS. 5 and 6, the dielectric green sheet laminate 110a may be cut in the lamination direction (T-axis direction) to form the pre-capacitor body 110b in which one end of the conductive paste layers 121b and 122b is exposed (e.g., step P2). In an embodiment, one end of the conductive paste layers 121b and 122b in the width direction (W-axis direction) may be exposed as the third surface S3 and the fourth surface S4 according to the cutting. For example, the dielectric green sheet laminate 110a may be cut to a predetermined size by dicing, or the like.

Since one end of the width direction (W-axis direction) of the conductive paste layers 121b and 122b is exposed to the outside without a separate width direction (W-axis direction) dielectric margin portion inside the pre-capacitor body 110b, deformation or damage of the internal electrodes 121 and 122 formed by firing the conductive paste layers 121b and 122b during a process such as pressurization or firing may be suppressed. Accordingly, the structural stability and reliability of the multilayer ceramic capacitor 100 may be improved.

By firing the pre-capacitor body 110b, the capacitor body 110 including a plurality of dielectric layers 111 and a plurality of internal electrodes 121 and 122 laminated in the lamination direction (T-axis direction) may be formed (e.g., step P3).

The firing conditions may be appropriately adjusted depending on the primary component composition of the dielectric layer 111, the primary component composition of the internal electrodes 121 and 122, or the composition of the margin slurry. For example, the firing temperature may be about 1200° C. to about 1350° C., or about 1220° C. to about 1300° C., and the time may be 0.5 hour to 8 hours, or 1 hour to 3 hours. The firing atmosphere may be a reducing atmosphere—for example, an atmosphere in which a mixture of nitrogen gas (N₂) and hydrogen gas (H₂) is humidified. When the internal electrodes 121 and 122 include nickel (Ni) or a nickel (Ni) alloy, the oxygen partial pressure in the firing atmosphere may be about 1.0×10⁻¹⁴ MPa to about 1.0×10⁻¹⁰ MPa.

After the firing, annealing may be performed as needed. Annealing is a treatment to reoxidize the dielectric layer, and annealing may be performed if firing is performed in a reducing atmosphere. The conditions of the annealing treatment may also be appropriately adjusted depending on the main component composition of the dielectric layer. For example, the annealing temperature may be 950° C. to 1150° C., the time may be 0 to 20 hours, and the rate of temperature rise may be about 50° C./hour to about 500° C./hour. The annealing atmosphere may be a humidified nitrogen gas (N₂) atmosphere, and the oxygen partial pressure may be about 1.0×10⁻⁹ MPa to about 1.0×10⁻⁵ MPa.

In the debinder treatment, sintering treatment, or annealing treatment, for example, a wetter may be used to humidify nitrogen gas or mixed gas, and in this case, the water temperature may be about 5° C. to about 75° C. The firing and annealing treatments may be performed sequentially or independently.

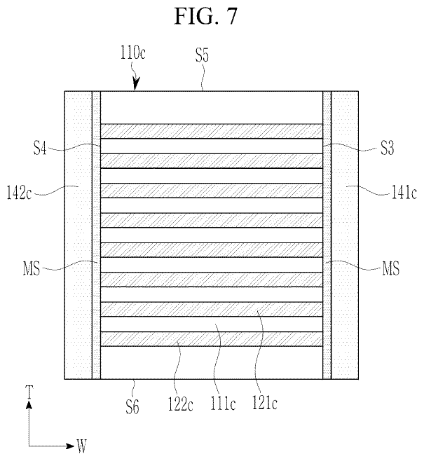

Referring to FIG. 7, a margin slurry MS including a polyvinyl butyral (PVB)-Nb composite may be applied on the margin sheets 141c and 142c (e.g., step P4). The margin sheets 141c and 142c and the margin slurry MS may then be located on a capacitor body 111c so that the margin slurry MS covers the exposed end of internal electrodes 121c and 122c (e.g., step P5).

The margin slurry MS and the margin sheets 141c and 142c may be attached to the third surface S3 and the fourth surface S4 of the capacitor body 111c so that the margin slurry MS contacts the third surface S3 and the fourth surface S4 facing the width direction (W-axis direction) of the capacitor body 110. Accordingly, the active region including the internal electrodes 121 and 122 may be protected from external impact and/or contamination.

The margin sheets 141c and 142c may include the above-described barium titanate-based compound. The margin sheets 141c and 142c may be sheets or layers including the barium titanate-based compound.

The PVB-Nb composite may include a compound in which PVB and Nb are bonded through a chemical bond. The PVB and Nb are chemically bonded, so that the average size of grains of components (Ti, Nb) included in the margin coating layers 141 and 142 may be reduced and the density may be improved. Accordingly, the reliability and stability of the margin coating layers 141 and 142 described later may be improved.

The PVB-Nb composite may include a polymer including PVB-derived repeating units, polyvinyl alcohol (PVA)-derived repeating units, and polyvinyl acetate (PVAc)-derived repeating units. The terminal functional group of the polymer may be bonded to an Nb ion (Nb⁵⁺), thereby realizing a stable bond between polymers.

The PVB-Nb composite is formed by adding a PVB source and an Nb source to a solvent, mixing, and drying.

The solvent may include an organic solvent or an aqueous solvent, such as terpineol, butyl carbitol, alcohol, methyl ethyl ketone, acetone, toluene, and the like. For example, ethanol may be used as the solvent.

The PVB source may include a polymer including PVB-derived repeating units, PVA-derived repeating units and PVAc-derived repeating units.

The PVB source may further include a repeating unit having a carboxyl group (—COOH) at a terminal. The carboxyl group of the PVB source polymers and the Nb ion (Nb⁵⁺) of the Nb source may be bonded to form the PVB-Nb composite. In addition, the interfacial bonding strength and moisture resistance reliability of the capacitor body 110 and the margin slurry during formation of the margin coating layers 141 and 142 may be further improved by the strong hydrogen bonding force of the carboxyl group.

The Nb source may include niobium ethoxide.

The Nb ions of the PVB-Nb composite included in the margin slurry MS may diffuse into the margin sheets 141c and 142c during the firing described below.

The margin slurry may further include a barium titanate-based compound.

The barium titanate-based compound included in the margin slurry may include BaTiO₃, CaTiO₃, SrTiO₃, or the like. These may be used alone or in combination of two or more.

The Nb ion of the PVB-Nb composite replaces the Ti ion of the barium titanate-based compound, which improves the electrical properties of ceramics, such as the dielectric constant, and may reduce the grain size. Accordingly, the driving stability and reliability of the multilayer ceramic capacitor 100 may be improved.

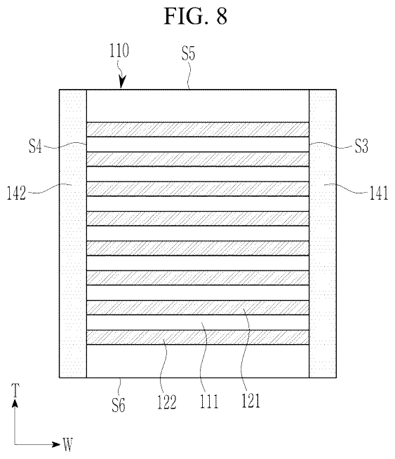

Referring to FIGS. 7 and 8, the margin coating layers 141 and 142 may be formed by firing the margin slurry MS and the margin sheets 141c and 142c (e.g., step P6).

With the firing, the margin slurry MS and the margin sheets 141c and 142c may be substantially converted into integral margin coating layers 141 and 142.

With the firing, the Nb ions of the PVB-Nb composite in the margin slurry MS may diffuse within the margin coating layers 141 and 142; for example, they may be located entirely within the margin coating layers 141 and 142.

During the firing, the grain size of the ceramic material including the barium titanate-based compound, etc. in the margin slurry MS and the margin sheets 141c and 142c is reduced by the PVB-Nb composite described above, and the density, moisture resistance reliability, and interfacial bonding strength with the capacitor body 110 of the margin coating layers 141 and 142 may be improved.

The firing conditions of the margin slurry MS and the margin sheets 141c and 142c may be substantially the same as or similar to the firing conditions of the pre-capacitor body 110b described above.

In some embodiments, the Nb content included in the margin coating layers 141 and 142 may be about 0.5 parts by mole to about 1 part by mole based on 100 parts by mole of Ti included in the margin coating layers 141 and 142. In the above range, the density and adhesive strength of the margin coating layers 141 and 142 during firing may be sufficiently improved, so that the moisture resistance, reliability, and structural stability of the multilayer ceramic capacitor 100 may be further improved.

Optionally, surface treatment such as sand blasting, laser irradiation, barrel polishing, etc. may be performed on the first surface S1 and the second surface S2 of the manufactured capacitor body 110. By performing this surface treatment, the ends of the first internal electrode 121 and the second internal electrode 122 may be exposed to the outermost surfaces of the first surface S1 and the second surface S2. Accordingly, the electrical bonding between the first external electrode 131 and the first internal electrode 121 and the electrical bonding between the second external electrode 132 and the second internal electrode 122 are improved, and alloy portions may be easily formed.

The external electrodes 131 and 132 may be formed on one surface (e.g., the first surface S1 and the second surface S2) of the manufactured capacitor body 110.

For example, a paste for forming a sintered metal layer may be applied to the outer surface of the capacitor body 110 and then sintered to form a sintered metal layer.

The paste for forming a sintered metal layer may include the conductive metal and glass described above. Additionally, the paste for forming a sintered metal layer may optionally include a binder, a solvent, a dispersant, a plasticizer, an oxide powder, or the like. The binder may include at least one selected from the group consisting of, for example, ethyl cellulose, acrylic, butyral, and the solvent may include, for example, an organic solvent or an aqueous solvent such as terpineol, butyl carbitol, alcohol, methyl ethyl ketone, acetone, toluene, or the like.

As a method of applying the paste for forming the sintered metal layer to the outer surface of the capacitor body 110, various printing methods such as a dipping method, screen-printing, a coating method using a dispenser, etc., a spraying method using a spray, etc. may be used.

The paste for forming the sintered metal layer may be applied to at least the first surface S1 and the second surface S2 of the capacitor body 110, and optionally may be applied to a portion of the third surface S3, the fourth surface S4, the fifth surface S5, or the sixth surface S6 on which the band portions of the first external electrode 131 and the second external electrode 132 are formed.

Thereafter, the capacitor body 110 onto which the paste for forming the sintered metal layer is applied may be dried and sintered at a temperature of 700° C. to 1000° C. for 0.1 to 3 hours to form the sintered metal layer.

Optionally, a paste for forming a conductive resin layer may be applied to the outer surface of the obtained capacitor body 110 and then cured to form a conductive resin layer.

The paste for forming the conductive resin layer may include a resin and, optionally, a conductive metal or a non-conductive filler. Since the description of the conductive metal and resin is the same as described above, repeated description will be omitted. Additionally, the paste for forming the conductive resin layer may optionally include a binder, solvent, dispersant, plasticizer, or oxide powder. The binder may include, for example, ethyl cellulose, acryl, butyral, etc., and the solvent may include an organic solvent or an aqueous solvent such as terpineol, butyl carbitol, alcohol, methyl ethyl ketone, acetone, toluene, or the like.

For example, the conductive resin layer may be formed by dipping the capacitor body 110 in a paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

A plating layer may be formed on the outside of the conductive resin layer.

For example, the plating layer may be formed by a plating method, sputtering, or electrolytic plating (electric deposition).

Specific embodiments of the present disclosure are provided below. The following examples are only intended to specifically illustrate or describe the present disclosure.

### Example 1

### (Preparation of PVB-Nb Composite)

As a PVB source, a solution was prepared by adding 10 g of PVB containing a —COOH group at the terminal to 100 mL of ethanol solvent.

0.1 g of niobium ethoxide was added to the above solution and mixed to form a mixture.

The above mixture was stirred and dried at 90° C. to prepare a PVB-Nb composite.

### (Preparation of Margin Slurry and Margin Sheet)

The PVB-Nb composite, BaTiO₃ powder, and solvent were mixed to prepare a margin slurry.

A margin sheet having a thickness of approximately 15 μm (maximum length in the width direction) was prepared using barium titanate powder.

The margin slurry was applied to one surface of the margin sheet to a thickness of about 20 nm (maximum length in the width direction).

The content of the PVB-Nb composite was adjusted so that the Nb content was 0.5 part by mole based on 100 parts by mole of Ti included in the margin slurry and margin sheet.

### (Manufacturing of Multilayer Ceramic Capacitor)

A dielectric green sheet laminate was prepared by preparing a dielectric green sheet using barium titanate (BaTiO₃) as the primary component powder, then printing a conductive paste layer containing nickel (Ni) on the surface of the dielectric green sheet, and laminating and pressing the dielectric green sheet in the lamination direction (T-axis direction) with the conductive paste layer located on the surface.

The dielectric green sheet laminate was cut in the lamination direction (T-axis direction) to form a pre-capacitor body (width×length×height=3.2 mm×2.5 mm×2.5 mm) in which one end of the conductive paste layer is exposed in the width direction (W-axis direction), and the pre-capacitor body was fired under the conditions of a firing temperature of 1400° C. or lower and a hydrogen concentration of 1.0% H₂ or lower through a plasticizing process in a nitrogen atmosphere at 400° C. or lower, thereby manufacturing a capacitor body. The capacitor body has internal electrodes exposed on the third surface and the fourth surface facing in the width direction (W-axis direction).

Two assemblies of the margin slurry and the margin sheet were attached to each of the two surfaces (the third surface and the fourth surface) of the capacitor body so that the margin slurry was in contact with the third surface and the fourth surface of the capacitor body. The margin slurry and the margin sheet were fired under the same conditions and methods as those for firing the pre-capacitor body to form a margin coating layer with a thickness of 15 μm (maximum length in the width direction).

Next, a multilayer ceramic capacitor was manufactured by applying external electrodes, plating and other processes on the first and second surfaces of the capacitor body described above.

### Example 2

A PVB-Nb composite, a margin slurry, a margin sheet, and a multilayer ceramic capacitor were manufactured using the same method as in Example 1, except that the content of the PVB-Nb composite was adjusted so that the Nb content was 0.75 part by mole based on 100 parts by mole of Ti contained in the margin slurry and margin sheet.

### Example 3

A PVB-Nb composite, a margin slurry, a margin sheet, and a multilayer ceramic capacitor were manufactured using the same method as in Example 1, except that the content of the PVB-Nb composite was adjusted so that the Nb content was 1.0 part by mole based on 100 parts by mole of Ti contained in the margin slurry and margin sheet.

### Comparative Example 1

A margin slurry, a margin sheet and a multilayer ceramic capacitor were prepared using the same method as in Example 1, except that an equivalent amount of PVB (BL-S grade) was used instead of the PVB-Nb composite.

### Comparative Example 2

A PVB-Nb composite, a margin slurry, a margin sheet, and a multilayer ceramic capacitor were manufactured using the same method as in Example 1, except that the content of the PVB-Nb composite was adjusted so that the Nb content was 0.25 part by mole based on 100 parts by mole of Ti contained in the margin slurry and margin sheet.

### Comparative Example 3

A PVB-Nb composite, a margin slurry, a margin sheet, and a multilayer ceramic capacitor were manufactured using the same method as in Example 1, except that the content of the PVB-Nb composite was adjusted so that the Nb content was 1.25 parts by mole based on 100 parts by mole of Ti contained in the margin slurry and margin sheet.

The Nb content of Examples 1 to 3 and Comparative Examples 1 to 3 described above may be measured through TEM-EDS analysis as described above.

### Evaluation 1: Connectivity of Margin Coating Layer and Capacitor Body

According to the above-described examples and comparative examples, 100 multilayer ceramic capacitors were prepared, and the periphery of each multilayer ceramic capacitor was fixed with epoxy resin.

The multilayer ceramic capacitor was polished using a polisher so that a cross-section (W-T cross-section) cut in the width direction (W-axis direction) and the lamination direction (T-axis direction) perpendicular to the length direction from the center of the length direction (L-axis direction) was exposed.

Among the exposed W-T cross-sections, the boundary region between the dielectric layer of the capacitor body and the margin coating layer was processed with focused ion beam (FIB), and TEM-EDS analysis images were obtained. Specifically, in the W-T cross-section, a square region having a length of 20 μm in the width direction (W-axis direction) and a length of 200 μm in the lamination direction (T-axis direction) was set, with the line extending in the width direction (W-axis direction) passing through the center of the lamination direction (T-axis direction) of the multilayer ceramic capacitor as the center line. The square region was divided into 10 sub-square regions each having a width direction (W-axis direction) length of 20 μm and a lamination direction (T-axis direction) length of 20 μm. TEM-EDS analysis was performed on each of the sub-square regions to determine whether cracks with a major axis length of 0.1 μm or more were visually observed between the capacitor body and the margin coating layer.

The number of multilayer ceramic capacitors in which cracks were observed among 100 multilayer ceramic capacitors was converted into ppm, and if it was 1000 ppm or more, it was evaluated as “NG,” and if it was less than 1000 ppm, it was evaluated as “OK.”

TEM-EDS analyses were performed using a JEM-ARM 200F/Elite T 1071 from JEOL at a magnification of 10 k and an acceleration voltage of 200 kV.

Although TEM-EDS was used in Evaluation 1 above, SEM analysis or optical microscopy analysis may be performed on the W-T cross-section to observe the cracks and evaluate connectivity in the same way.

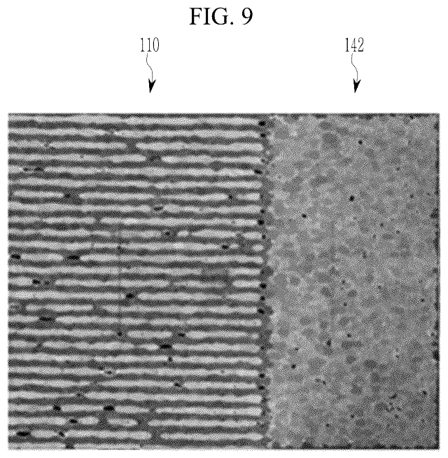

FIG. 9 is a scanning electron microscopy-microstructure image database and analysis system (SEM-MiDAS) analysis image of the multilayer ceramic capacitor according to Example 1.

A GeminiSEM 360 from Zeiss was used as the SEM device. MiDAS analysis was performed using software (MiDAS 2.3) developed by Samsung Electro-Mechanics.

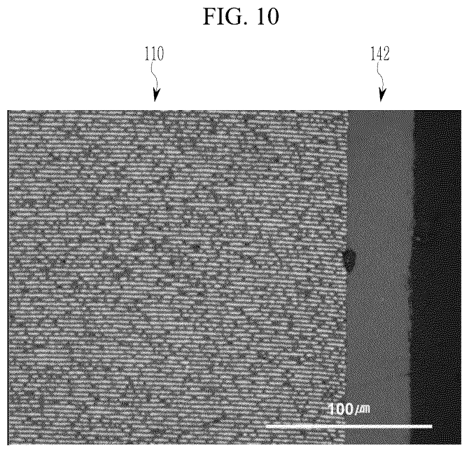

FIG. 10 is an optical microscope image of the multilayer ceramic capacitor according to Comparative Example 1. Specifically, the multilayer ceramic capacitor of Comparative Example 1 was polished using a polisher so that the cross-section (W-T cross-section) cut in the width direction (W-axis direction) and the lamination direction (T-axis direction) perpendicular to the length direction from the center of the length direction (L-axis direction) was exposed.

An optical microscope was set to a magnification of 100×, and the boundary between the margin coating layer and the capacitor body of the W-T cross-section was photographed to obtain the image in FIG. 10.

Referring to FIGS. 9 and 10, in Example 1 using the PVB-Nb composite, no cracks were observed at the boundary between the capacitor body and the margin coating layer, but in Comparative Example 1, cracks were observed.

### Evaluation 2: Density Analysis of the Margin Coating Layer

For multilayer ceramic capacitors manufactured according to the examples and comparative examples, the periphery of the multilayer ceramic capacitor was fixed with epoxy resin.

The multilayer ceramic capacitor was polished using a polisher so that a cross-section (W-T cross-section) cut in the width direction (W-axis direction) and the lamination direction (T-axis direction) perpendicular to the length direction from the center of the length direction (L-axis direction) was exposed.

SEM-MiDAS analysis images were obtained for the margin coating layer of the W-T cross-section. Specifically, in the W-T cross-section, a square region having a length of 20 μm in the width direction (W-axis direction) and a length of 200 μm in the lamination direction (T-axis direction) was set, with the line extending in the width direction (W-axis direction) passing through the center of the lamination direction (T-axis direction) of the multilayer ceramic capacitor as the center line. The square region was divided into 10 sub-square regions each having a width direction (W-axis direction) length of 20 μm and a lamination direction (T-axis direction) length of 20 μm. SEM analysis images were obtained for each of the sub-square regions, and the number of pores was measured for the SEM analysis images using a microstructure image database and analysis system (MiDAS) 2.3 program. Additionally, the grain size was evaluated visually. If the average number of pores in the 10 sub-square regions was 20 or more, it was evaluated as “NG,” and if it was less than 20, it was evaluated as “OK.”

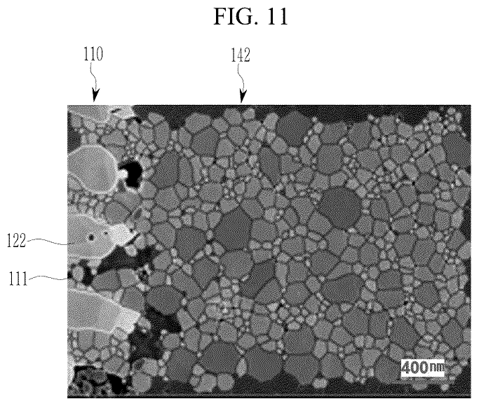

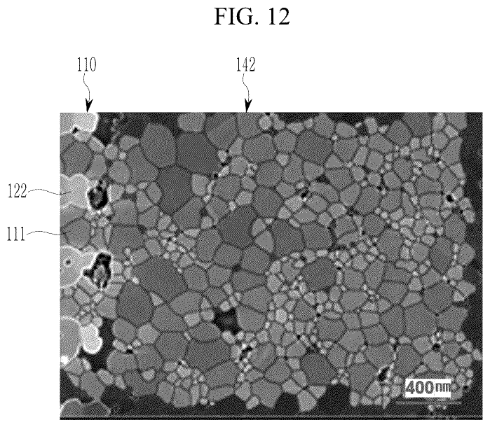

FIG. 11 is an SEM-MiDAS analysis image of the multilayer ceramic capacitor according to Example 1. FIG. 12 is an SEM-MiDAS analysis image of the multilayer ceramic capacitor according to Comparative Example 1.

Referring to FIGS. 11 and 12, in Example 1, the grain size and the number of pores of the margin coating layer were relatively smaller than in Comparative Example 1, thereby improving the density, stability, and moisture resistance reliability of the multilayer ceramic capacitor.

### Evaluation 3: Moisture Resistance Analysis

Each of 40 multilayer ceramic capacitors according to the above-described examples and comparative examples was prepared, and for each multilayer ceramic capacitor, the change in internal resistance (IR) was measured for 12 hours under conditions of 85° C., 95% relative humidity, and 6.3 V using ESPEC (PR-3J, 8585) equipment to evaluate the operating life.

If the average operating life of the 40 multilayer ceramic capacitors was less than or equal to 8 hours, it was evaluated as “NG,” and if it exceeded 8 hours, it was evaluated as “OK.”

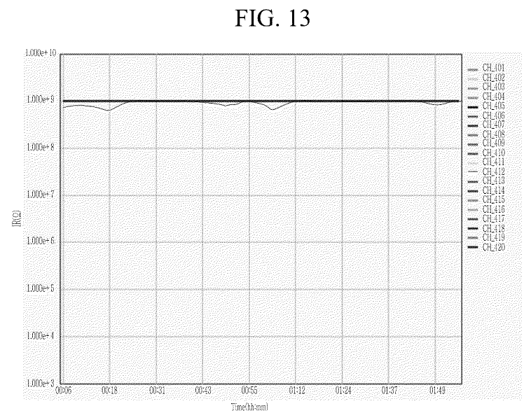

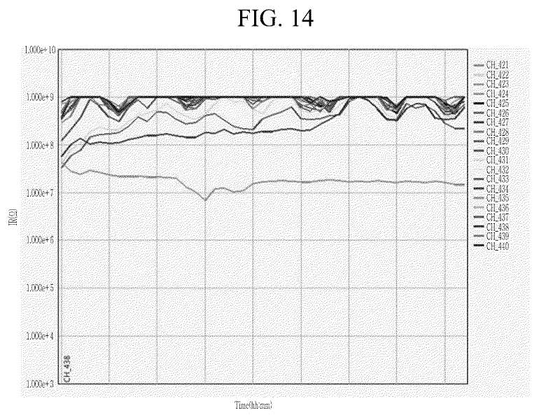

FIG. 13 is a graph showing the results of a moisture resistance reliability evaluation of the multilayer ceramic capacitor according to Example 1. FIG. 14 is a graph showing the results of a moisture resistance reliability evaluation of the multilayer ceramic capacitor according to Comparative Example 1.

Referring to FIGS. 13 and 14, in Example 1, the internal resistance was maintained relatively stable compared to Comparative Example 1.

The content of Nb based on 100 parts by mole of Ti in the margin coating layer and the evaluation results are shown in Table 1 below. In Table 1, connectivity shows the results of the connectivity evaluation of the margin coating layer and the capacitor body.

TABLE 1

| | Nb content | Moisture | | |
|---|---|---|---|---|
| | (parts by | resistance | | |
| | mole) | reliability | Connectivity | Density |
| Example 1 | 0.5 | OK | OK | OK |
| Example 2 | 0.75 | OK | OK | OK |
| Example 3 | 1 | OK | OK | OK |
| Comparative | 0 | NG | NG | NG |
| Example 1 | | | | |
| Comparative | 0.25 | NG | OK | NG |
| Example 2 | | | | |
| Comparative | 1.25 | NG | OK | NG |
| Example 3 | | | | |

Referring to Table 1, in examples in which the Nb content of the margin coating layer formed using the margin slurry including the PVB-Nb composite was 0.5 part by mole to 1 part by mole based on 100 parts by mole of Ti, the moisture resistance reliability, the connectivity between the margin coating layer and the capacitor body, and the density of the margin coating layer were relatively improved compared to the comparative examples. Accordingly, the multilayer ceramic capacitors of the examples have relatively improved structural stability and reliability compared to the multilayer ceramic capacitors of the comparative examples.

### DESCRIPTION OF SYMBOLS

100: Multilayer ceramic capacitor
110: Capacitor body
111: Dielectric layer
121: First internal electrode
122: Second internal electrode
131: First external electrode
132: Second external electrode
141: First margin coating layer
142: Second margin coating layer

What is claimed is:

1. A multilayer ceramic capacitor, comprising:
a capacitor body having a first surface and a second surface facing in a first direction, a third surface and a fourth surface facing in a second direction and connecting the first surface and the second surface, and a fifth surface and a sixth surface facing in a third direction and connecting the first surface and the second surface, and including a plurality of dielectric layers and a plurality of internal electrodes laminated in the third direction;
an external electrode located on an outer surface of the capacitor body; and
a margin coating layer disposed on the third surface and the fourth surface and including a barium titanate-based compound and Nb,
wherein a Nb content included in the margin coating layer is 0.5 part by mole to 1 part by mole based on 100 parts by mole of Ti included in the margin coating layer.

2. The multilayer ceramic capacitor of claim 1, wherein
the maximum length of the margin coating layer in the second direction is greater than 0 μm and less than or equal to 20 μm.

3. The multilayer ceramic capacitor of claim 1, wherein
the external electrode is disposed on the first surface and the second surface.

4. The multilayer ceramic capacitor of claim 1, wherein
the margin coating layer is in contact with the dielectric layer or the internal electrode.

5. The multilayer ceramic capacitor of claim 1, wherein
at least one surface of the margin coating layer is exposed to an outside of the multilayer ceramic capacitor.

6. A method of manufacturing a multilayer ceramic capacitor, comprising:
forming a dielectric green sheet laminate by laminating dielectric green sheets on which a conductive paste layer is formed in a third direction;
cutting the dielectric green sheet laminate in the third direction to form a pre-capacitor body with one end of the conductive paste layer exposed;
firing the pre-capacitor body to form a capacitor body including a plurality of dielectric layers and a plurality of internal electrodes laminated in the third direction;
applying a margin slurry including a polyvinyl butyral (PVB)-Nb composite on a margin sheet;
positioning the margin sheet and the margin slurry on the capacitor body so that the margin slurry covers the exposed end of the internal electrode; and
firing the margin slurry and the margin sheet to form a margin coating layer,
wherein a Nb content included in the margin coating layer is 0.5 part by mole to 1 part by mole based on 100 parts by mole of Ti included in the margin coating layer.

7. The method of manufacturing the multilayer ceramic capacitor of claim 6, wherein
in the PVB-Nb composite, the PVB and Nb are bonded through a chemical bond.

8. The method of manufacturing the multilayer ceramic capacitor of claim 6, wherein
the PVB-Nb composite comprises a PVB-derived repeating unit, a polyvinyl alcohol (PVA)-derived repeating unit, and a polyvinyl acetate (PVAc)-derived repeating unit.

9. The method of manufacturing the multilayer ceramic capacitor of claim 6, wherein
the PVB-Nb composite is formed by adding a PVB source and a Nb source into a solvent, mixing, and drying.

10. The method of manufacturing the multilayer ceramic capacitor of claim 9, wherein
the PVB source comprises a polymer including PVB-derived repeating units, PVA-derived repeating units and PVAc-derived repeating units.

11. The method of manufacturing the multilayer ceramic capacitor of claim 10, wherein
the polymer further comprises a repeating unit having a carboxyl group at a terminal.

12. The method of manufacturing the multilayer ceramic capacitor of claim 11, wherein
Nb ions included in the Nb source are bonded to the carboxyl group to form the PVB-Nb composite.

13. The method of manufacturing the multilayer ceramic capacitor of claim 9, wherein
the Nb source comprises niobium ethoxide.

14. The method of manufacturing the multilayer ceramic capacitor of claim 6, wherein
the margin slurry further comprises a barium titanate-based compound.

15. The method of manufacturing the multilayer ceramic capacitor of claim 6, wherein
the capacitor body has a first surface and a second surface facing in a first direction, a third surface and a fourth surface facing in a second direction and connecting the first surface and the second surface, and a fifth surface and a sixth surface facing in a third direction and connecting the first surface and the second surface,
the margin coating layer is located on the third surface and the fourth surface,
and the maximum length of the margin coating layer in the second direction is greater than 0 μm and less than or equal to 20 μm.
